(19) United States
(12) Patent Application Publication
(10) Pub. No.: US 2008/0191477 A1
(43) Pub. Date: Aug. 14, 2008

(54) Trunking Connector Assembly

(76) Inventor: Richard John Thompson, Bishop Auckland (GB)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/793,570

(22) PCT Filed: Dec. 14, 2005
(86) PCT No.: PCT/GB05/04820

§ 371 Date: Apr. 2, 2008

(30) Foreign Application Priority Data
Dec. 20, 2004 (GB) 0427743.0

(51) Int. Cl. F16L 25/00

(52) U.S. Cl. 285/330; 285/420

(57) ABSTRACT

A connector for connecting a first section of trunking to a second section of trunking is disclosed. The connector has an extension portion which is adapted to extend through a first opening in an end of a first section of trunking and through a second opening in an end of a second section of trunking when the end of the trunking sections are engaged with each other. There is also a retaining portion for preventing the extension portion from being pulled from said first trunking section through said openings to said second trunking section. The connector also has a clamping device for applying a clamping force at a plurality of separate locations around said first and second opening to retain said first and second trunking sections in engagement with each other.

The present invention relates to a connector for connecting two sections of trunking together, and relates particularly, but not exclusively, to connectors for joining sections of trunking with a waterproof joint.

Where sections of waterproof trunking are joined together, it is well known to use trunking with externally mounted flanges which can be bolted together. Trunking with such flanges is difficult to clean and the externally mounted fixings tend to create dirt traps. Such dirt traps are particularly undesirable where trunking is used in the food, beverage or pharmaceutical industries where hygiene is of paramount importance.

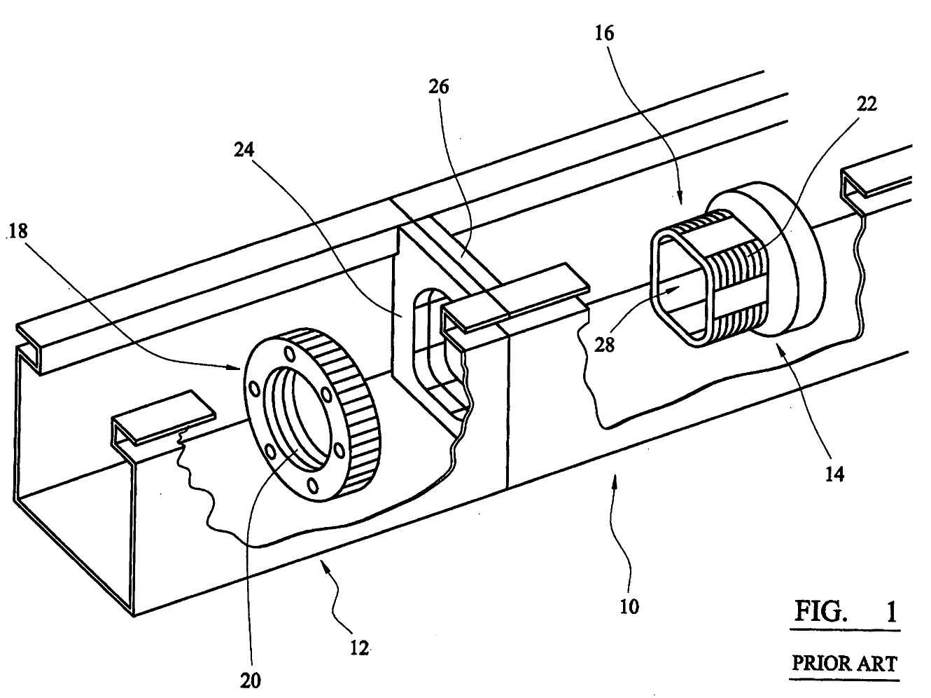

An example of a trunking connector which overcomes such problems is described in a UK patent application published under number GB2399610, the disclosure in which is incorporated herein by reference. The apparatus disclosed therein is shown in FIG. 1 in which it can be seen that two trunking sections 10 and 12 are connected by a bush connector 14 having a male part 16 and female part 18 which has a threaded internal portion 20 which engages an externally threaded portion 22 on male part 16. The threaded portion 22 extends through apertures in internal flanges 24 and 26 once female part 18 is threaded onto threaded portion 22, the first and second trunking portions 10 and 12 are held in position.

A connector of this type has the disadvantage that the aperture 28 in male part 16, through which cables are passed, is considerably smaller than the internal cross-section of the trunking sections. The size of aperture 26 is limited by the need to rotate female part 18 around the male part 16, the threads 22 on male part 22 and the squaring off of some rounded surfaces on male part 16 to prevent rotation of the trunking sections 10 and 12. It is recommended that the cables in a trunking assembly do not fill more than 40% of the cross-section of the smallest aperture in the assembly. As a result, with the already considerably restricted aperture 28, the cables in the remainder of the trunking sections will fill considerably less than 40% of the available cross-section. Therefore space and materials in the production of the trunking sections are wasted.

A further problem with trunking sections of the prior art is the joining of cut ends of the trunking sections. When assembling a series of trunking sections it is unlikely that the space to be filled with the trunking sections will have dimensions which fall within a multiple of the standard lengths of trunking sections. As a result, it will be necessary to cut at least one trunking section in order to fill a space smaller than a standard trunking length. As a result, one end of the trunking section will not be provided with a flange, whether internal or external, and a means for joining this cut end of trunking to another section of trunking is required. Existing connectors of this type are only suitable for externally flanged trunking and involve a considerable number of parts and seals, all externally mounted, which present significant difficulties in cleaning the apparatus.

Preferred embodiments of the present invention seek to overcome problems with the prior art.

According to an aspect of the present invention, there is provided a connector for connecting a first section of trunking to a second section of trunking, the connector comprising:
at least one extension portion adapted to extend through a first opening in a first section of trunking and through a second opening in a second section of trunking when engaged with said first section;
at least one retaining portion for preventing at least one said extension portion from moving from said first trunking section through said openings to said second trunking section; and
at least one clamping portion for applying a clamping force at a plurality of separate locations around said first and second opening to retain said first and second trunking sections in engagement with each other.

By applying a clamping force at a plurality of separate locations around the first and second opening, the advantage is provided that the size of the aperture through which cables can be passed relative to the cross-section of the body of the trunking which the connector is joined to is significantly increased compared to the aperture available in internally flanged trunking section and associated connectors of the prior art. As a result, more cables can be put into the sections of trunking, thereby providing better use of the space occupied by the trunking sections. Furthermore, because the device set out above does not require a large bush thread and accompanying nut, the advantage is provided that the cost of producing the parts required for the present invention is significantly less, both due to the volume of material used and the precision with which the parts of the connector must be made to still provide a waterproof seal. As a result, the apparatus of the present invention is easier and cheaper to manufacture.

The connector may further comprise at least one surface engaging portion, for engaging an internal surface of said second trunking section adjacent said second opening.

The connector may also further comprise at least one seal.

In a preferred embodiment at least one said seal is located between said first and second trunking sections.

In another preferred embodiment at least one said seal is located between said first surface engaging portion and an internal surface of said first trunking section and at least one said seal is located between said second surface engaging portion and an internal surface of said second trunking section.

In a further preferred embodiment at least one said seal comprises at least one O-ring.

At least one of the seals may comprise at least one sealing material attached to at least one of said retaining portion and/or surface engaging portion.

In a preferred embodiment at least one retaining portion is attached to at least one said extension portion.

At least one of the retaining parts may comprise:
at least one connecting portion for connecting at least one said retaining part to at least one said extension portion; and
at least one first force applying portion for applying said clamping force by pulling at least one said first surface engaging portion towards at least one said first force applying portion.

In a preferred embodiment at least one said retaining part comprises at least one stud adapted to engage at least one respective aperture in said extension portion.

In another preferred embodiment at least one said first force applying portion further comprises at least one threaded portion adapted to engage a respective threaded portion of said connecting portion.

In a further preferred embodiment said first force applying portion further comprises at least one arm portion adapted to rotate relative to said connecting portion and having at least one shaped surface adapted to engage either said surface engaging portion or an internal surface of said second trunking section.

At least one of the retaining parts may comprise:
at least one first force applying portion adapted to engage said first surface engaging portion; and
at least one second force applying portion adapted to apply said clamping force by pulling at least one said first surface engaging portion towards at least one said second force applying portion.

According to another aspect of the present invention, there is provided a connector for connecting a first section of trunking to a second section of trunking, the connector comprising:
at least one first extension portion having at least one channel extending therethrough for receiving cables and adapted to extend into a first trunking section, at least one said extension portion having a plurality of surface engaging portions adapted to at least partially engage internal surfaces of said trunking section, at least one said surface engaging portion extending substantially around external surfaces of said extension portion;
at least one first retaining device adapted to retain at least one said extension portion relative to said trunking section; and
at least one end engaging portion extending at least partially around said extension portion and adapted to engage at least one end surface or edge of at least one said trunking section.

By providing a connector, as set out above, the advantage is provided that an internally located connector can be provided to connect one or more cut ends of trunking with the remainder of a trunking assembly. As a result, cut ends of a waterproof trunking section can be connected using an internal connector whilst maintaining a waterproof connection. Because the plurality of surface engaging portions extend around the extension portion, each surface engaging portion provides a waterproofing barrier through which water must pass to gain access to the inside of the trunking. With a plurality of such surface engaging portions, the likelihood of water entering the trunking assembly is minimised or reduced to zero.

The connector may further comprise at least one second extension portion and at least one second retaining device.

In a preferred embodiment at least one said extension portion is tubular.

In another preferred embodiment at least one said surface engaging portion comprises at least one rib.

At least one rib may have a substantially triangular cross-section.

By providing a rib having a substantially triangular cross-section, the advantage is provided that the triangular cross-section can be orientated to encourage movement of the connector into the trunking section and resist the withdrawal of the connector.

In a preferred embodiment at least one retaining device comprises at least one aperture in said extension portion corresponding to an aperture in said trunking section and adapted to receive at least one fixing therein.

In another preferred embodiment at least one said end engaging portion comprises a first surface in use substantially co-planar with an external surface of said trunking section and/or a lid thereon.

The connector may further comprise at least one seal.

Preferred embodiments of the present invention will now be described, by way of example only, and not in any limitative sense, with reference to the accompanying drawings in which:

FIG. 1 is a perspective view of a trunking connector of the prior art;

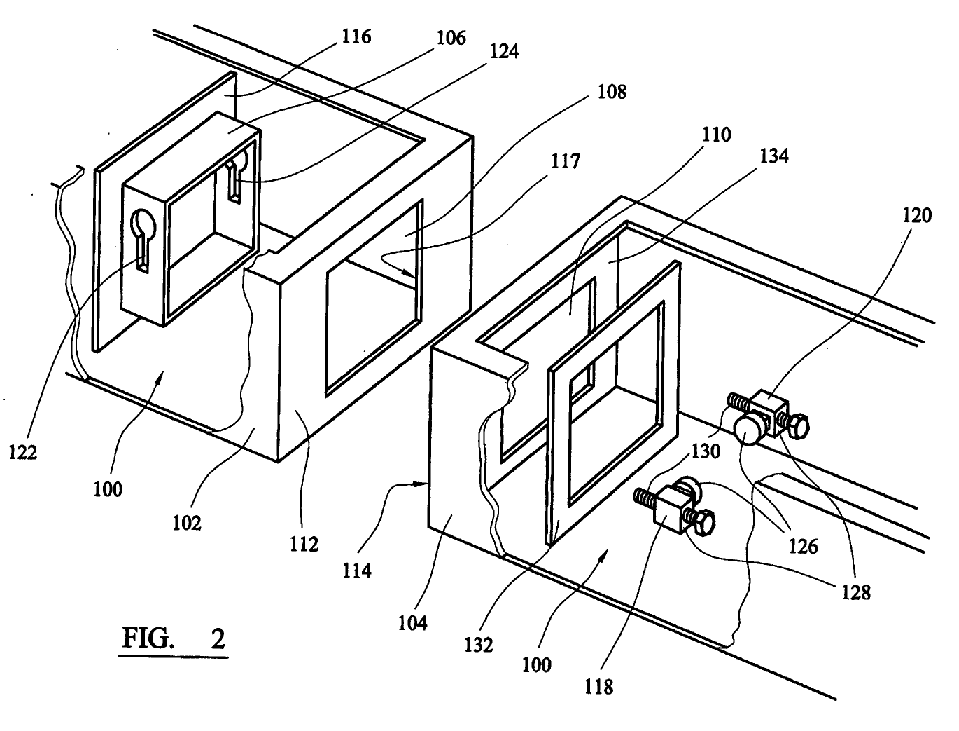

FIG. 2 is a perspective view of a trunking connector of a first embodiment of the present invention;

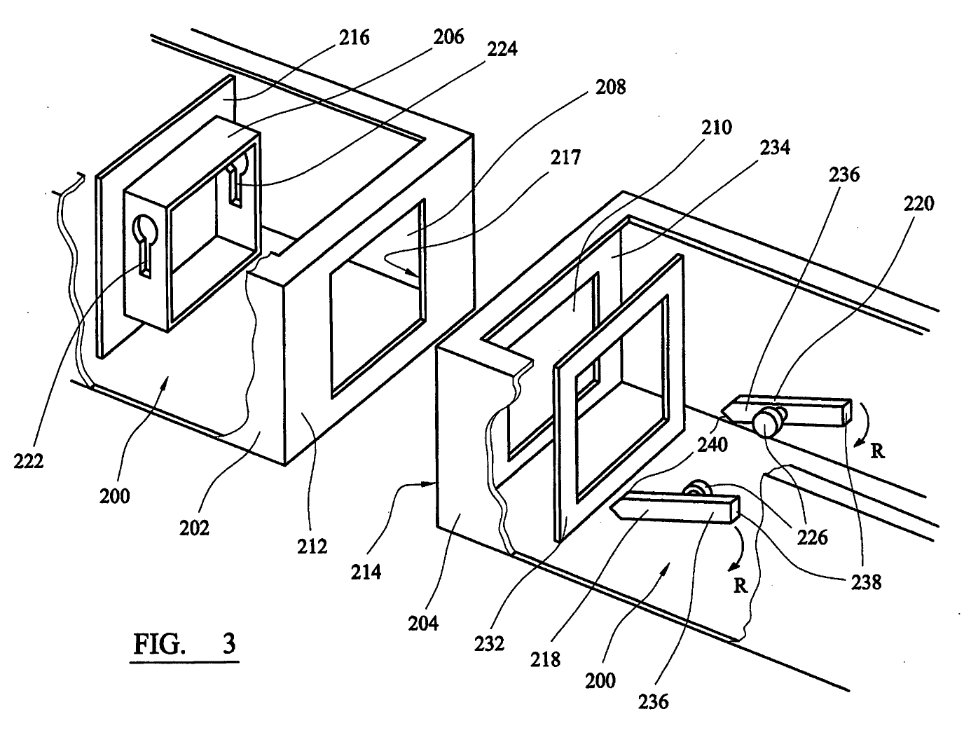

FIG. 3 is a perspective view of a trunking connector of a second embodiment of the present invention;

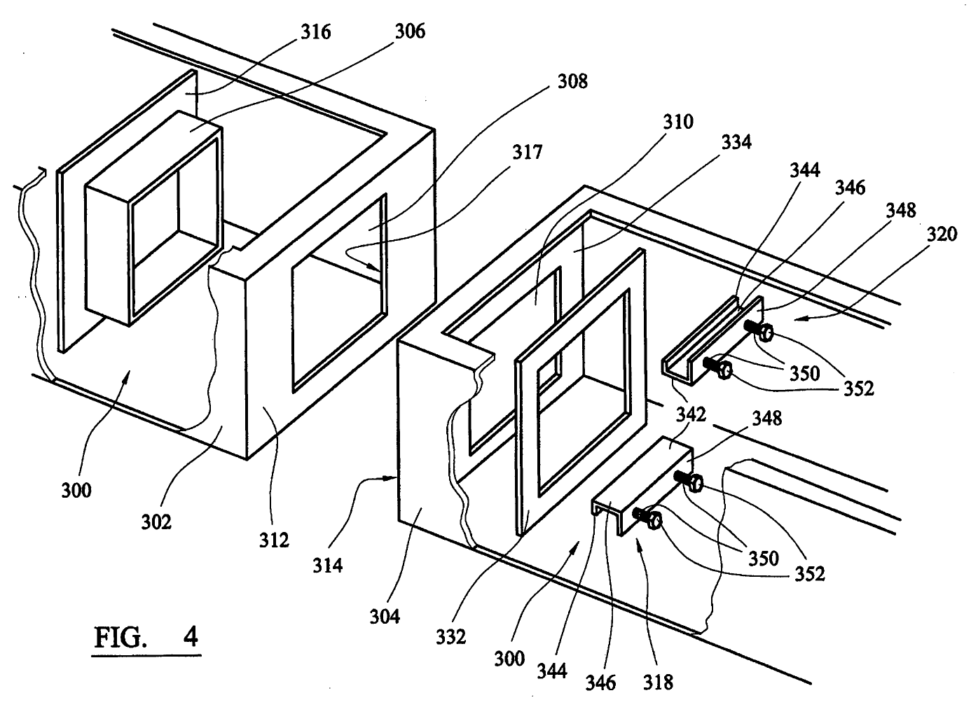

FIG. 4 is a perspective view of a trunking connector of a third embodiment of the present invention; and

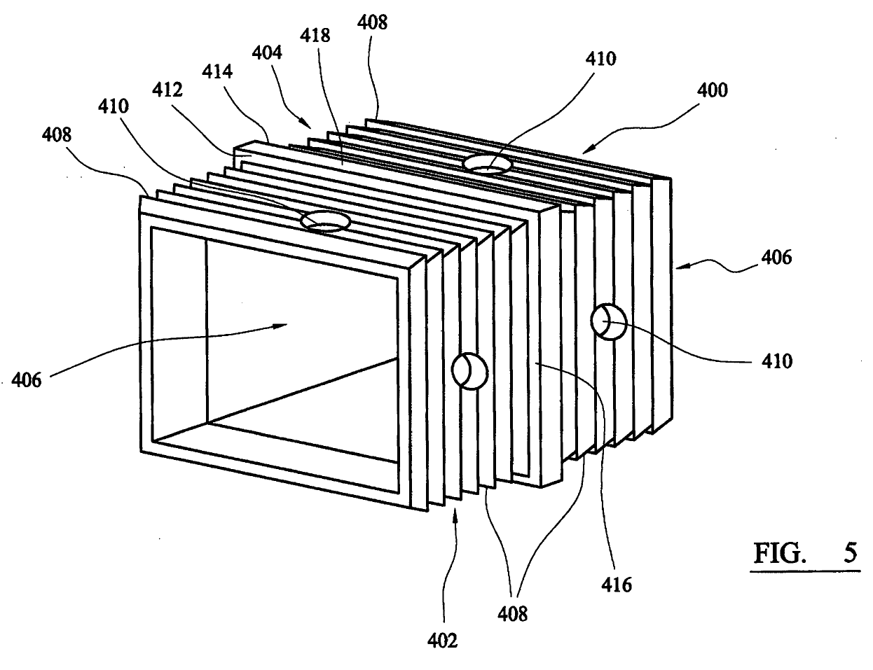

FIG. 5 is a perspective view of a trunking connector of a fourth embodiment of the present invention.

Referring to FIG. 2, a connector, generally shown at 100, for connecting a first section of trunking 102 to a second section of trunking 104, has a first extension portion 106 which is adapted to extend through a first opening or aperture 108 in first trunking section 102 and through a second opening or aperture 110, the second section of trunking 104 when the external end faces, respectively 112 and 114, of first and second trunking sections 102 and 104, are engaged with each other. Extension portion 106 has a retaining portion or flange 116 which prevents the extension portion 106 from passing from the first trunking section 102 through the first and second apertures 108 and 110 and into the second trunking section 104. The connector 100 also has clamping parts 118 and 120 which are adapted to engage with extension portion 106 in key ways 122 and 124 so as to apply a clamping force at a plurality of locations around the first and second apertures 108 and 110 so as to retain the first and second trunking sections 102 and 104 in engagement with each other. The clamping parts 118 and 120 have studs 126 which extend into key ways 122 and 124. The studs 126 are attached to threaded portions 128 which have internal threads to receive bolts 130.

The connector 100 also includes a surface engaging portion 132 which is adapted to engage an internal surface 134 of second trunking section 104. For a waterproof trunking device, one or more seals (not shown)are used to prevent water entering the trunking sections 102 and 104. A pair of seals could be provided, the first located between the flange 116 and internal surface 117 of first trunking section 102 and a second seal located between the surface engaging portion 132 and internal surface 134 of trunking section 104. These seals could be O-rings or alternatively a sealing material could be applied to the surfaces of flange 116 and surface engaging portion 132 that engage the internal surfaces 117 and 134. In particular with surface engaging portion 132, it is important that the seal is provided around the internal edge of the surface engaging portion 132 so as to prevent water from entering between the external end faces 112 and 114 and passing along the extension portion 106 as it extends into the second trunking section 104. Alternatively, or in addition, a single seal could be provided between the two end faces 112 and 114. If this seal was provided, the second surface engaging portion 132 could be omitted with the clamping parts 118 and 120 acting directly on internal surface 134.

In use, first and second trunking sections 102 and 104 are brought into engagement with each other so that apertures 108 and 110 are aligned. An O-ring seal may be placed between end surfaces 112 and 114. Extension portion 106 is inserted into first trunking section 102 and located so that it extends through the first and second apertures 108 and 110 and partially into second trunking section 104. Flange 116 prevents the extension portion 106 from passing through apertures 108 and 110 and into second trunking section 104. If O-rings are being used to seal the connection between the trunking sections by locating them on the extension portion, the first O-ring would be located on the extension portion before it is positioned in apertures 108 and 110 and a second O-ring is placed around extension portion 106 once it is located through second aperture 110.

Once the extension portion 106 and O-rings are in position, the surface engaging portion 132 is located over the extension portion 106. The surface engaging portion 132 is pressed into engagement with internal surface 134 using clamping parts 118 and 120. Studs 126 are located in the circular portions of key way 122 and 124 and slid down into the slots located below the circular portions. The bolts 130 are rotated so as to apply a clamping force to surface engaging portion 132 and thereby pulling the extension portion 106 and flange 116 towards the second trunking section 104. As a result, the first and second trunking sections 102 and 104 are held in close engagement with each other and sealed relative to the outside. Finally, lids (not shown) are located on trunking sections 102 and 104.

Referring to FIG. 3, in which parts common with those of FIG. 2 are denoted with like-referenced numerals increased by 100, a connector 200 for trunking sections 202 and 204 has many parts in common with that described above, except for the operation of the clamping parts 218 and 220. Studs 226, similar to those seen in FIG. 2, are provided and engage key ways 222 and 224 in extension portion 206. However, the stud 226 is connected to a bar 236 having first ends 238 and second ends 240 which have a chamfered or rounded profile.

In use, the extension portion 206 and surface engaging portion 232 are assembled with first and second trunking portions 202 and 204 as previously described. The clamping parts 218 and 220 are inserted into key ways 222 and 224 so that the first ends 238 are elevated relative to second ends 240. Once located in position at the bottom of key ways 222 and 224, the clamping parts 218 and 220 are rotated in direction R about studs 226 so that second ends 240 are lifted into engagement with surface engaging portion 232. A locking means (not shown) such as a small protrusion in the external surface of extension portion 226 adjacent the key ways prevents further rotation of the bars 236. The second ends 240 are shaped so as to encourage rotation in direction R thereby assisting in clamping the surface engaging portion 232 against internal surface 234 of trunking section 204 and holding the two trunking sections in engagement.

Referring to FIG. 4, in which parts common with those of FIG. 3 are denoted with like-referenced numerals increased by 100, a connector 300 for connecting first and second trunking sections 302 and 304 has an extension portion 306 with a retaining portion 316 attached thereto. The connector also has a surface engaging portion 332 and these features operate in a similar manner to those previously described. However, the connector 300 differs from those previously described in that clamping parts 318 and 320 do not engage with key ways in the extension portion 306. Instead, the clamping portions 318 and 320 have force applying portion in the form of a U-shaped clamp 342 which has a first side 344 which engages the retaining portion 316, a joining portion 346 which extends over the extension portion 306 and a second side 348 having threaded apertures 350 therein. Bolts 352 are located in apertures 350 and are rotated to engage the surface engaging portion 332 so as to apply a clamping force pulling the retaining portion 316 towards the surface engaging portion 332 thereby clamping the trunking sections 302 and 304 together.

The use of the clamping part 318, in the base of the apertures 308 and 310, means that the edges of the central surface 346 provide a smooth support for cables passing through the apertures.

It should be noted that the present invention could equally apply to lay down in cable trunking provided in a U-shaped channel with a U-shaped connector as to the feed through trunking and connector shown in the examples in FIGS. 2-4. However, the use of such a device with U-shaped trunking is unlikely to provide a fully waterproof seal.

Referring to FIG. 5, a connector 400 for connecting two sections of trunking (not shown) has a first extension portion 402 and a second extension portion 404, which both have a channel in the form of aperture 406 extending there through. The aperture 406 receives cables (not shown) which are laid in the trunking sections. Each extension portion 402 and 404 has surface engaging portions, in the form of ribs 408, extending around the external surface of the extension portions 402 and 404. Ribs 408 engage internal surfaces of the trunking sections, creating a snug fit between the extension portions 402 and 404 and their respective trunking sections. The apparatus also has retaining devices in the form of blind threaded holes 410. These holes are adapted to be aligned with holes in the trunking sections and these pairs of holes receive a small threaded bolt thereby retaining the trunking sections in position on the connector and assisting with engaging the internal surfaces of the trunking sections with the ribs 408. The connector 400 further has an end engaging portion 412 having surfaces 414 and 416 which engage the edges or end surfaces of the trunking sections which are located on the connector 400.

In use, two trunking sections which have been cut to remove the internally flanged ends shown in FIGS. 2, 3 and 4, have holes drilled into their sides and into a corresponding lid so as to align with holes 410 when the trunking section and lids are in position on connector 400. The trunking sections are slid over extension portions 402 and 404 so that the holes in the trunking sections align with the holes 410 and the cut edges of the trunking sections engage with surfaces 414 and 416 of end engaging portion 412. The end engaging portion is dimensioned so that the surface 418 which joins surface 414 and 416 is substantially flush with the external surfaces of the trunking sections and corresponding lids. Bolts are inserted through the holes in the trunking sections and into blind threaded holes 410 and the bolts tightened. The connector 400 is formed from a plastic material which is of sufficient strength to firmly retain metal threads within holes 410 but sufficiently flexible that the ribs 408 are able to deform into engagement with the internal surfaces of the trunking sections and lids. As a result, a series of waterproof seals are formed by the ribs 408 and if one rib does not provide sufficient seal, the next rib will provide further resistance to the transfer of water towards the inside of the trunking section.

The embodiment shown is a feed-through type connector, requiring that the wires contained in the trunking sections are passed through the aperture 406. As an alternative, a U-shaped connector could be provided, although this would reduce the waterproofing effect of the connector.

It will be appreciated by persons skilled in the art that the above embodiment has been described by way of example only, and not in any limitative sense, and that various alterations and modifications are possible without departure from the scope of the invention as defined by the appended claims.

For example, the connector shown in FIG. 5 could be made from other materials than plastic. A connector of this type could be formed from metal or from metal with a coating of plastic. A further alternative would be to provide a metal connector with a series of grooves running around the periphery of the extension portions into which O-rings could be located. These O-rings would act as the surface engaging portions.

1. A connector for connecting a first section of trunking to a second section of trunking, the connector comprising:
at least one extension portion adapted to extend through a first opening in a first section of trunking and through a second opening in a second section of trunking when engaged with said first section;
at least one retaining portion for preventing at least one said extension portion from moving from said first trunking section through said openings to said second trunking section; and
at least one clamping portion for applying a clamping force at a plurality of separate locations around said first and second opening to retain said first and second trunking sections in engagement with each other.

2. A connector according to claim 1, further comprising at least one surface engaging portion, for engaging an internal surface of said second trunking section adjacent said second opening.

3. A connector according to claim 1, further comprising at least one seal.

4. A connector according to claim 3, wherein at least one said seal is located between said first and second trunking sections.

5. A connector according to claim 3, wherein at least one said seal is located between said retaining portion and an internal surface of said first trunking section and at least one said seal is located between said surface engaging portion and an internal surface of said second trunking section.

6. A connector according to claim 3, wherein at least one said seal comprises at least one O-ring.

7. A connector according to claim 3, wherein at least one said seal comprises at least one sealing material attached to at least one of said retaining portion and/or surface engaging portion.

8. A connector according to claim 1, wherein at least one retaining portion is attached to at least one said extension portion.

9. A connector according to claim 1, wherein at least one said retaining part comprises:
at least one connecting portion for connecting at least one said retaining part to at least one said extension portion; and
at least one first force applying portion for applying said clamping force by pulling at least one said first surface engaging portion towards at least one said first force applying portion.

10. A connector according to claim 9, wherein at least one said retaining part comprises at least one stud adapted to engage at least one respective aperture in said extension portion.

11. A connector according to claim 9, wherein at least one said first force applying portion further comprises at least one threaded portion adapted to engage a respective threaded portion of said connecting portion.

12. A connector according to claim 9, wherein said first force applying portion further comprises at least one arm portion adapted to rotate relative to said connecting portion and having at least one shaped surface adapted to engage either said surface engaging portion or an internal surface of said second trunking section.

13. A connector according to claim 1, wherein at least one said retaining part comprises:
at least one first force applying portion adapted to engage said first surface engaging portion; and
at least one second force applying portion adapted to apply said clamping force by pulling at least one said first surface engaging portion towards at least one said second force applying portion.

14. (canceled)

15. A connector for connecting a first section of trunking to a second section of trunking, the connector comprising:
at least one first extension portion having at least one channel extending therethrough for receiving cables and adapted to extend into a first trunking section at least one said extension portion having a plurality of surface engaging portions adapted to at least partially engage internal surfaces of said trunking section, at least one said surface engaging portion extending substantially around external surfaces of said extension portion;
at least one first retaining device adapted to retain at least one said extension portion relative to said trunking section; and
at least one end engaging portion extending at least partially around said extension portion and adapted to engage at least one end surface or edge of at least one said trunking section.

16. A connector according to claim 15, further comprising at least one second extension portion and at least one second retaining device.

17. A connector according to claim 15, wherein at least one said extension portion is tubular.

18. A connector according to claim 15, wherein at least one said surface engaging portion comprises at least one rib.

19. A connector according to claim 18, wherein at least one said rib has a substantially triangular cross-section.

20. A connector according to claim 15, wherein at least one retaining device comprises at least one aperture in said extension portion corresponding to an aperture in said trunking section and adapted to receive at least one fixing therein.

21. A connector according to claim 15, wherein at least one said end engaging portion comprises a first surface in use substantially co-planar with an external surface of said trunking section and/or a lid thereon.

22. A connector according to claim 15, further comprising at least one seal.

23. (canceled)
